(19) United States
(12) Patent Application Publication
(10) Pub. No.: US 2009/0008319 A1
(43) Pub. Date: Jan. 8, 2009

(54) Filter Assembly

(76) Inventor: Terence Butlin, Nottinghamshire (GB)

Correspondence Address: DICKSTEIN SHAPIRO LLP, 1825 EYE STREET NW, Washington, DC, 20006-5403, US

(21) Appl. No.: 11/917,757

(22) PCT Filed: May 16, 2006
(86) PCT No.: PCT/GB2006/001784

§ 371 Date: Jul. 25, 2008

(30) Foreign Application Priority Data
Jun. 18, 2005 (GB) 0512470.6

(51) Int. Cl. B30B 9/06

(52) U.S. Cl. 210/350; 425/404

(57) ABSTRACT

A movable die head for a cementitious press mould, the die head having a mould face (45) intended to contact and apply compression to a mixture (66) contained in the mould, the mould face being defined by at least one wear component (50) and a filter sheet (52).

The present invention relates to a mould face and a filter assembly, for use in a cementitious press mould such as a wet concrete, hermetic or semi-dry mix press mould, and in particular to a mould face and a filter assembly, for a movable press head of a press mould.

A known cementitious press mould comprises a mould cavity having closed lower and side walls. A metered amount of cementitious mix is placed into the mould cavity and a movable press head is then moved towards the closed lower wall, to apply a high compressive pressure on to the cementitious mix.

The press head comprises a die head having a mould face that comes into contact with the mixture contained in the mould. The die head is of a shape and size that corresponds to the cross-sectional shape and size of the mould cavity.

Various actions within the cementitious mix occur when the compressive pressure is applied. For example, in a wet concrete press mould, a wet concrete mix is compacted, it is shaped to the shape of the mould, and excess water is squeezed out of the wet mixture.

A result of these actions is the formation of a moulded product, such as a paving slab or kerb, for example.

The corner edges of the moulded product are usually the most brittle section of the product, especially when the products comprise paving slabs. It is known therefore to build up the corners of the die head to form corresponding depressed corners in the moulded product. The corners of the stacked mould products consequently are less likely to come into contact with one another, and therefore less likely damage the corners of other moulded products, when the products are stacked.

In a wet concrete press mould, excess water is conducted away from the die head under the assistance of a vacuum, created in the die head and through the lower surface of the mould cavity. It is known that the action of the press head causes the majority of the excess water to be expelled via the die head.

It has been found that during the moulding process, the compressive forces applied by the press head to the concrete mix cause a large proportion of the excess fluid to flow toward the edges of the die head, resulting in high pressure and frictional forces acting on the edges of the die head.

These high pressure and frictional forces result in the corners of the die head wearing out at a faster rate than other parts of the die head. The effect of the wear of the corners is that the corresponding depressed corners in the moulded products become increasingly shallow, thus increasing the likelihood that the corners of the moulded products will be damaged through contact with the corners of other products when stacked.

In order to maintain a consistent standard of mould products, it is known to replace the die head once the wear of the built up corners has reached an unacceptable level. This is time consuming and expensive, as the press mould cannot be used while the die head is being replaced. In addition, the die head itself is expensive.

Replacement of the whole die head is also wasteful since most of the die head is still in a usable state.

In a hermetic press mould, a cementitious mix designed specifically for the press mould is placed in the mould cavity. The cementitious mix usually consists of a face and back mix.

The face mix is normally comprises expensive aggregates with a high cement content and is generally very wet when discharged into the mould. The back mix is a weak semi dry cement mix, and is placed on top of the face mix within the cavity.

Due to the fact that a hermetic press mould comprises a sealed lower wall, cement enriched water from the face mix is forced thorough the back mix when under pressure from the press head.

In a semi-dry press mould, a semi dry mix having a higher cement content, and slightly wetter consistency than the back mix of a hermetic press mould, is placed in the mould cavity. The water/cement ratio of the mix is such that on compaction from either pressure or vibration, the mix forms a solid mass to the required strength.

According to a first aspect of the present invention, there is provided a movable die head for a cementitious press mould, the die head having a mould face intended to contact and apply compression to a cementitious mixture contained in the mould, the mould face being defined by at least one wear component and a filter sheet.

The at least one wear component is positioned where the high pressure and frictional forces acting on the mould face during the moulding process, result in excessive wear of the die head and/or filter.

Therefore the working life of the die head and/or filter is substantially increased as a constant wear across the whole mould face is achieved.

According to a second aspect of the present invention, there is provided a filter assembly, for use in a cementitious press mould, having a filter sheet and at least one wear component, the filter assembly defining a mould face intended to contact and apply compression to a mixture contained in the mould, the at least one wear component and the filter sheet collectively defining said mould face.

According to a third aspect of the present invention, there is provided a filter assembly for a die head for a cementitious press mould, the die head having a mould face intended to contact and apply compression to a mixture contained in the mould, the filter assembly defining the mould face for the die head, the filter assembly including a head plate which carries one r more wear component and to which a filter sheet is attached, the or each wear component and the filter sheet collectively defining said mould face.

Preferably the press mould is either a wet concrete, hermetic or semi-dry mix press mould.

Advantageously the or each wear component is positioned at, or close to an edge of a front face of the head plate.

Preferably the front face of the head plate is polygonally shaped.

Preferably the or each wear component is positioned at, or close to a corner of the front face of the head plate.

Preferably the or each wear component is detachably mounted on the head plate to enable removal and replacement of a worn wear component with the filter sheet remaining in situ.

Advantageously the or each wear component is seated in a recess formed in the head plate, the recess defining a shoulder against which the wear component abuts to resist sideways movement of the wear component relative to the head plate.

Advantageously the or each wear component is detachably secured to the plate by at least one fastener securely received in a corresponding socket formed in the head plate.

In a preferred embodiment, the at least one fastener comprises at least one pin depending from the wear component. Preferably the at least one pin is a split pin.

In another preferred embodiment, the fastener comprises a spigot that depends from the wear component.

Advantageously the or each wear component has a marginal cover portion which overlies a marginal edge of the filter sheet.

Advantageously the cover portion comprises a lateral side which is chamfered.

Preferably the or each wear component is formed of a non-compressible material.

Preferably the non-compressible material is a plastic polymer.

Preferably the filter sheet is formed from a filter material.

Advantageously the filter sheet material is a knitted or woven fabric.

The invention will now be further described by way of example only with reference to the accompanying drawings in which:

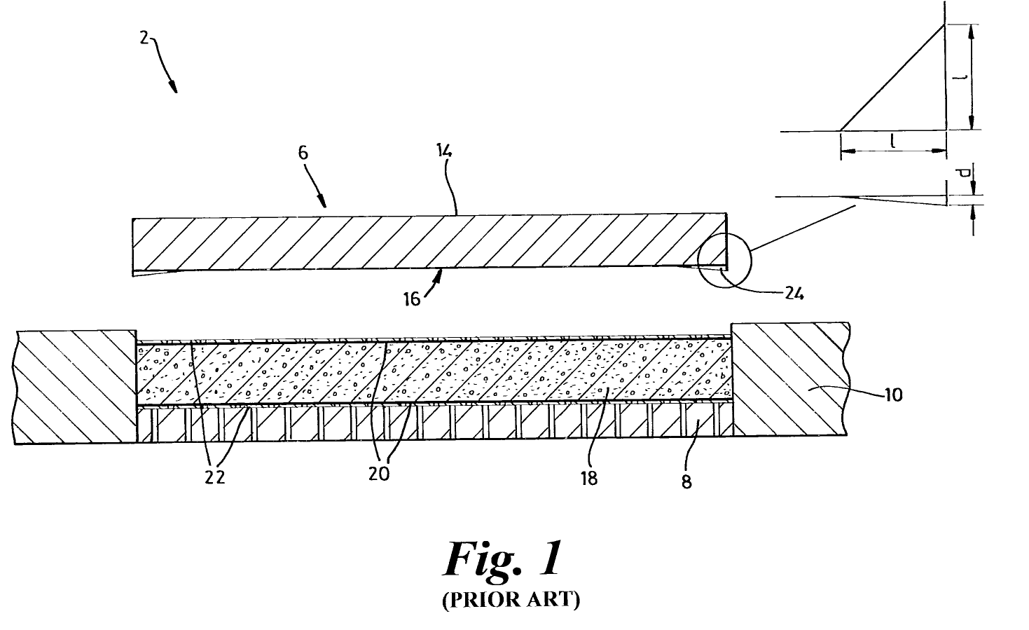

FIG. 1 is a side view of a wet concrete press mould including a loosely retained filter assembly, according to the prior art;

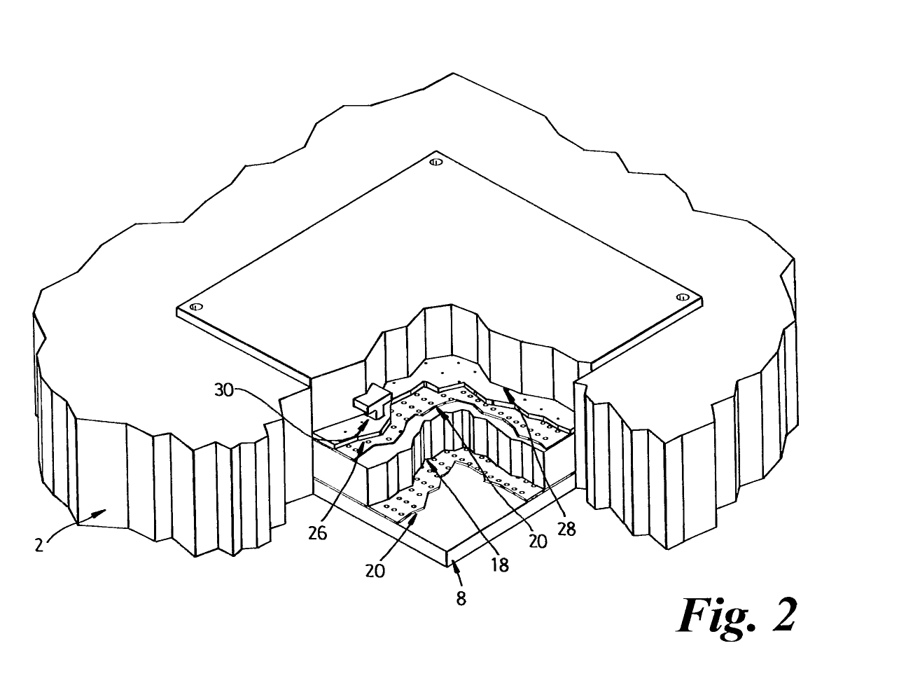

FIG. 2 is a cut-away view of a general arrangement of a press assembly within a press mould;

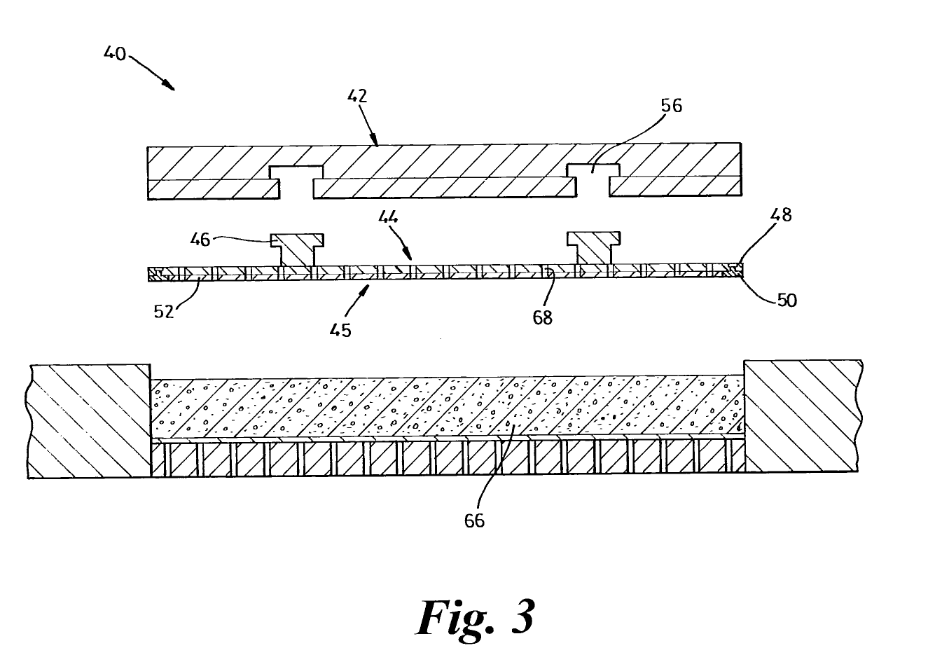

FIG. 3 is a side view of a wet concrete press mould including a filter assembly according to a first embodiment of the invention fixed to a movable die head;

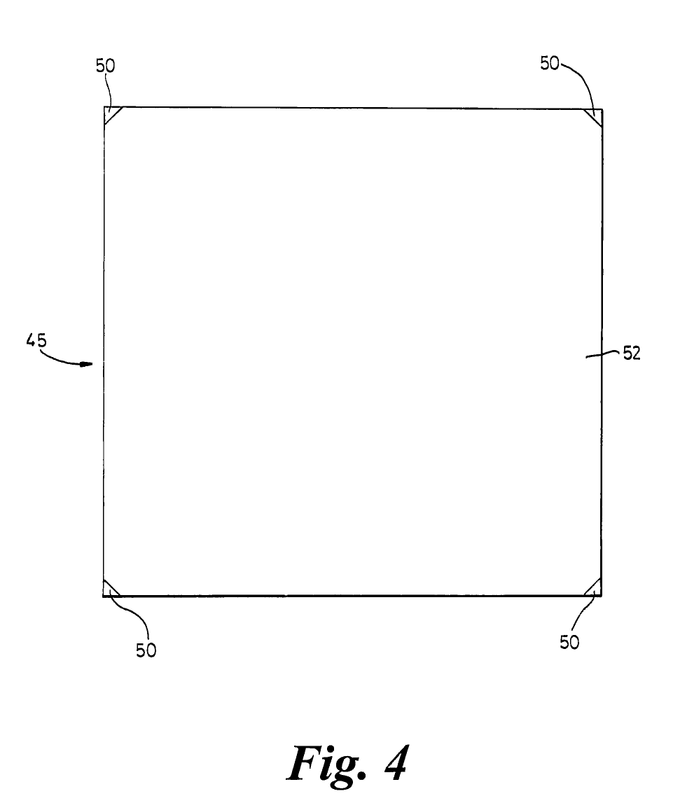

FIG. 4 is a plan view of a mould face according to an embodiment of the invention;

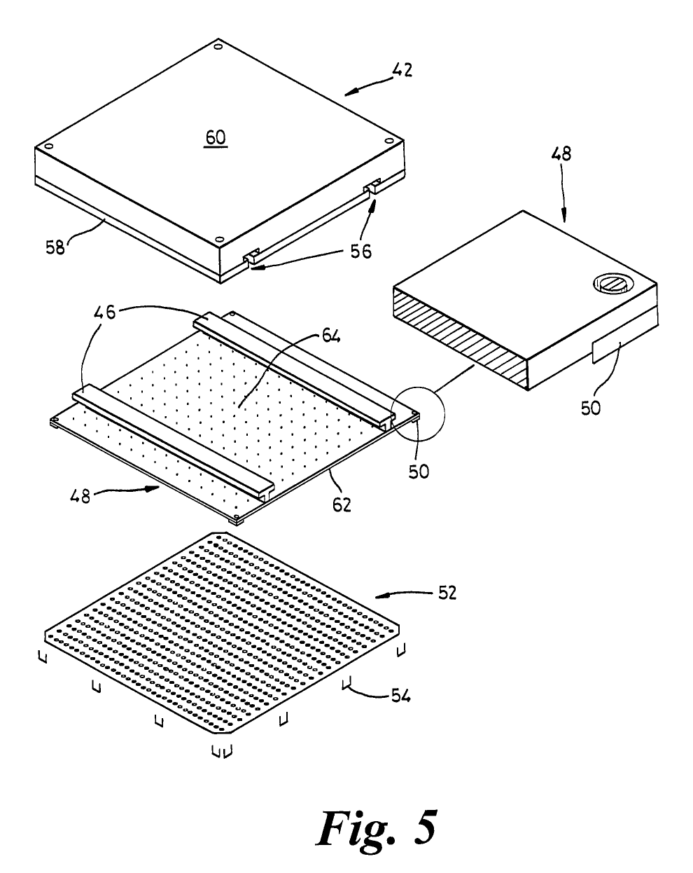

FIG. 5 is an exploded schematic view of the die head of FIG. 3;

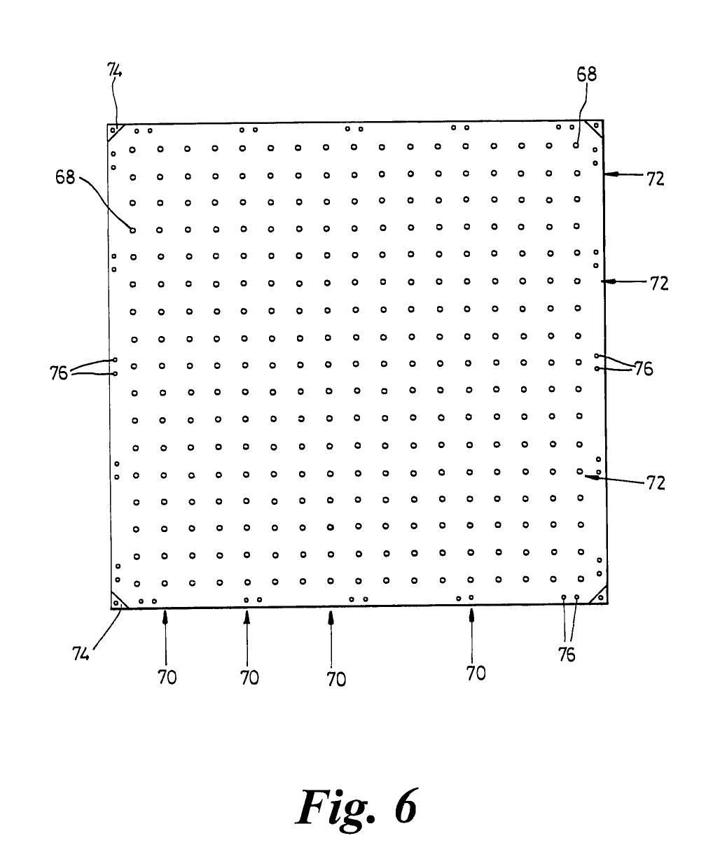

FIG. 6 is a schematic view of a head plate for the filter assembly shown in FIG. 3;

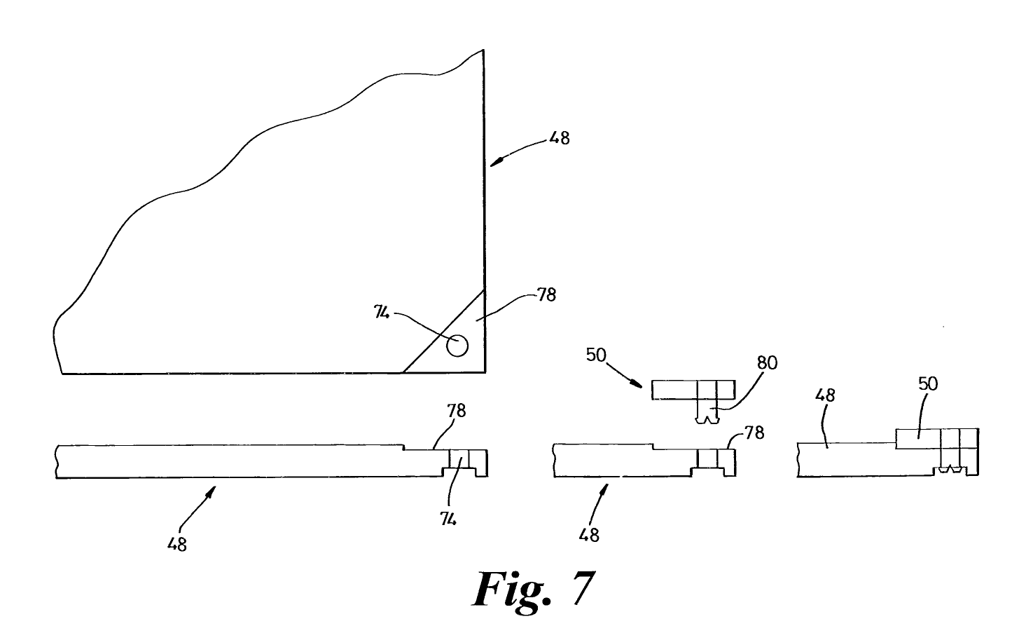

FIG. 7 is a schematic view of a wear component for the filter assembly of FIG. 3, being secured to the head plate of FIG. 6;

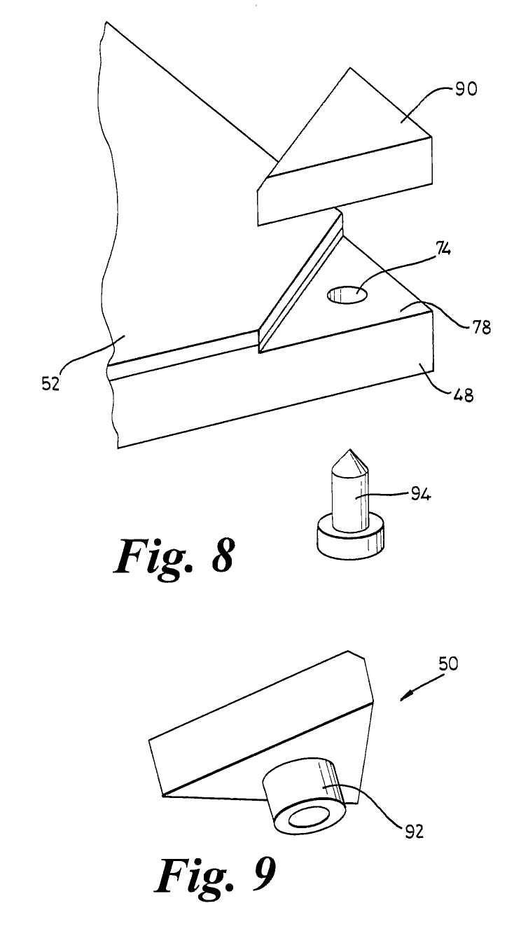

FIG. 8 is a schematic view of an alternative embodiment of a wear component for the filter assembly of FIG. 3;

FIG. 9 is a perspective view of the wear component of FIG. 8;

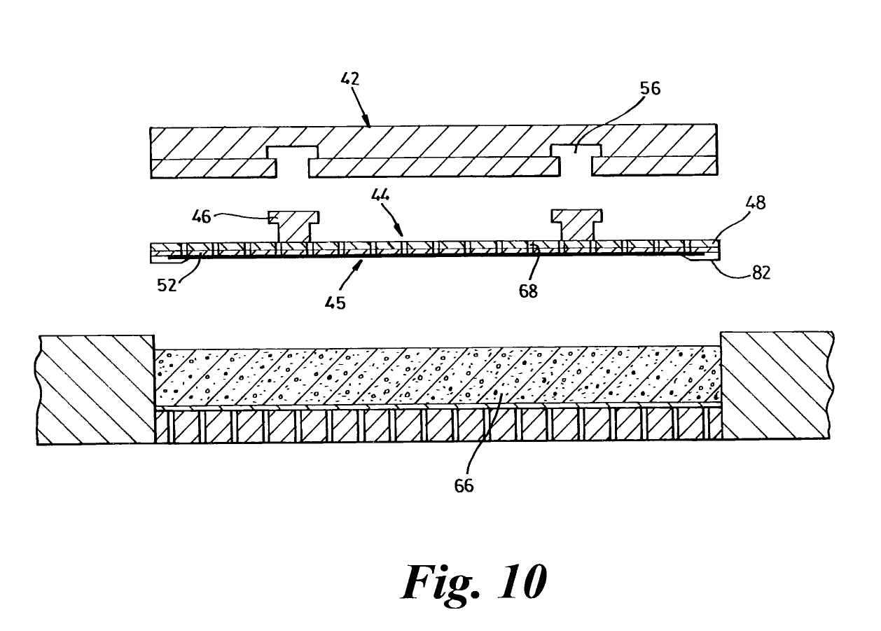

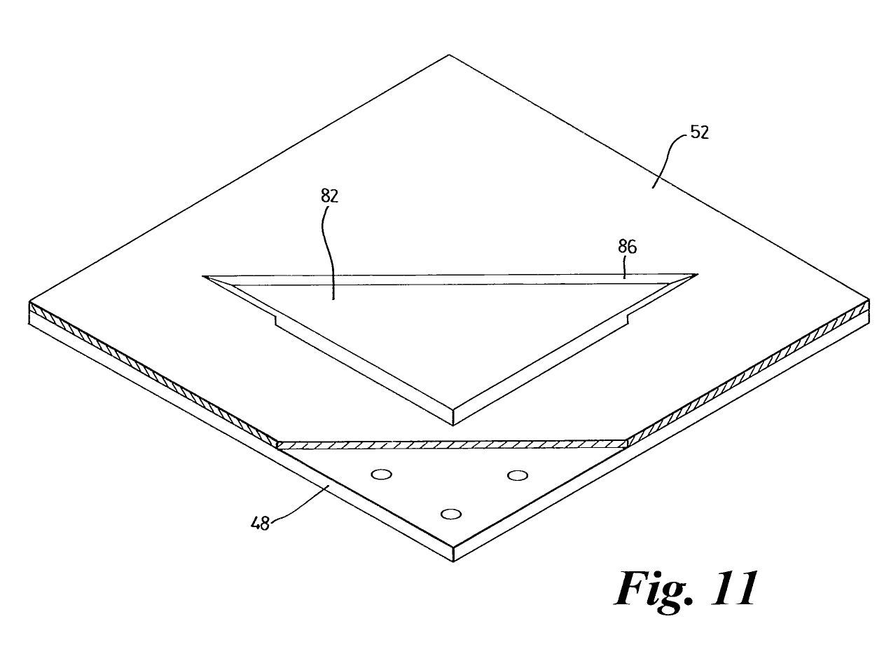

FIG. 10 is side view of a wet concrete press mould including a second embodiment of a filter assembly according to the invention fixed to a movable die head;

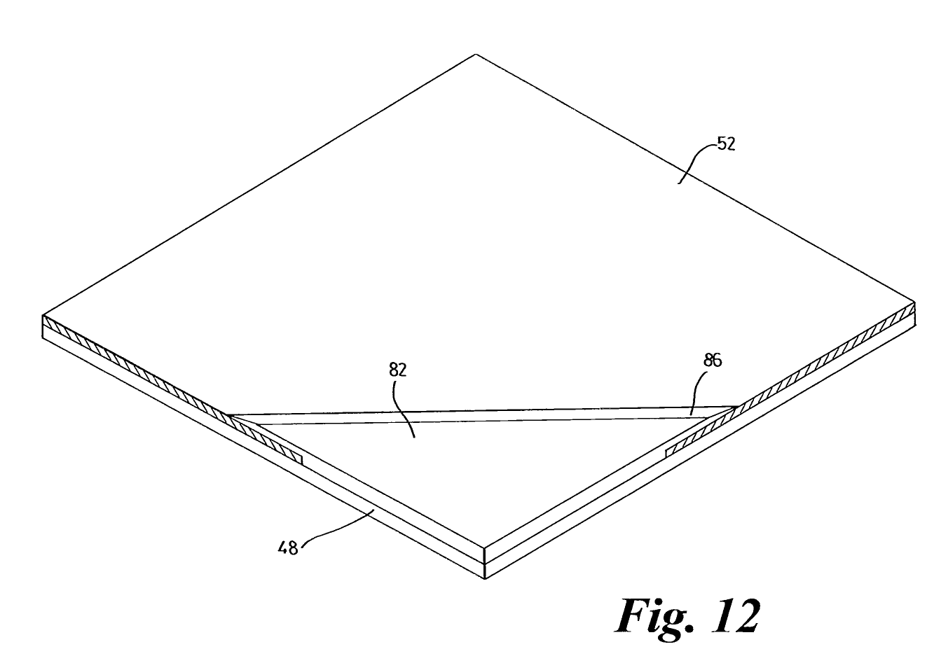

FIG. 11 is a schematic view of a wear component for use in the filter assembly of FIG. 10 in an unsecured state;

FIG. 12 is a schematic view of the wear component of FIG. 11 in a secured state;

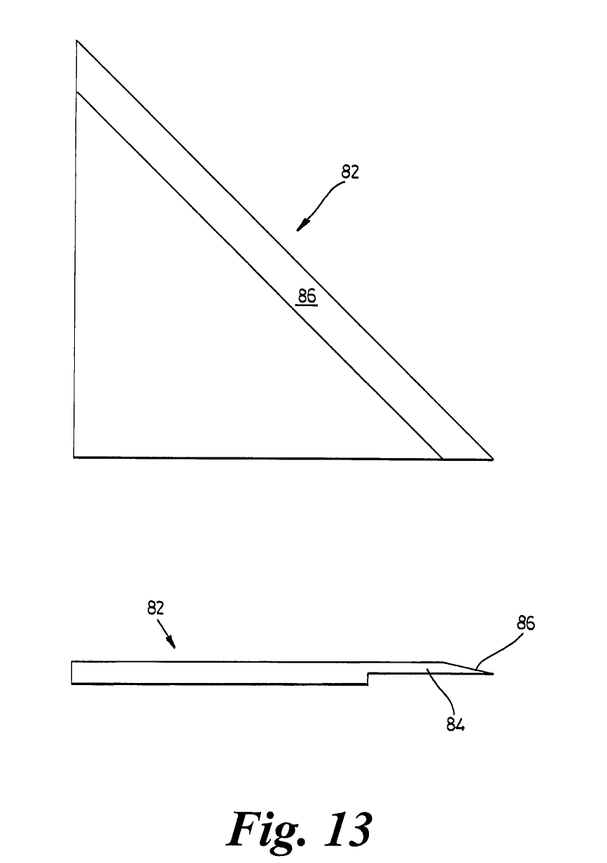

FIG. 13 is a schematic view of the wear component of FIGS. 11 and 12.

Referring initially to FIG. 1, a sectional view of a known press mould 2 for making concrete slabs 4 according to the art is shown. The mould 2 comprises a mould cavity having a closed lower wall 8 and sidewalls 10. The mould 2 further comprises a movable press head 6. The press head 6 includes a die head 14 having a mould face 16. The press head 6 is connected to a ram (not shown), which enables the mould face 16 to be movable towards the lower wall 8 for compressing cementitious material 18 therebetween for forming a concrete slab or kerb 4 or other product.

A filter is placed between the cementitious material 18 and the closed lower wall 8 and the die head 14 respectively, the filter between the cementitious material 18 and the die head 14 being loosely retained in the cavity.

In use, the filter overlays a surface of the closed lower wall 8 or die head 14 in order to provide a release for removal of the moulded product 4 from the mould and also to assist in preventing particulate material from exiting the mould via the closed lower wall 8 or the die head 14.

The filter typically comprises a filter sheet 20 and a mounting plate 22, and is arranged such that a face of filter sheet is in contact with the cementitious material. The mounting plate 22 being in contact with a corresponding face of the lower wall 8 or die head 14.

Built up corners 24 are added to the die head so as to form corresponding depressed corners in the moulded product 4. The built up corners 24 are wedge shaped and have a height d, corresponding to the required depressed depth of the corners of moulded product 4.

FIG. 2 shows a general arrangement of a press assembly within a mould.

A cementitious press mould including a filter assembly according to a first embodiment of the invention is shown in FIG. 3.

The press head 40 comprises a die head 42 and a filter assembly 44. The press head further comprises a mould face 45, which comes into contact with the cementitious mixture 66 within the mould.

The filter assembly 44 comprises a filter sheet 52, at least one wear component 50 and a head plate 48.

In the embodiment shown in FIG. 3, the filter assembly comprises a plurality of wear components 50.

The wear components 50 and the filter sheet 52, collectively define the mould face 45 of the press head 40 as shown in FIG. 4. The position of the wear components within the mould face 45 is at a location corresponding where high pressure and functional forces occur.

Inclusion of the wear components 50 to define the mould face enables the filter sheet 52 to be used many more times than previously possible while maintaining an acceptable quality of moulded product. In the conventional arrangement, the filter sheet 52 becomes worn at the locations where high pressure and frictional forces occur.

An exploded view of a press head 40 for a cementitious press mould including the filter assembly according to a first embodiment of the invention is shown in FIG. 5.

The die head 42 comprises a front face 58 and an opposite face 60. The head plate 48 of the filter assembly 44 comprises a front face 62 and an opposite face 64. The die head 42 and the head plate 48 are connectable such that the front face 58 of the die head 42 and the opposite face 64 of the head plate 48 face one another.

In the embodiment shown, the die head 42 and the head plate 48 are connectable by means of a pair of elongate bars 46, preferably having a T-shaped profile, attached to the opposite surface 64 of the head plate 48. Each elongate bar 46 is received in a corresponding T-shaped slot 56 in the die head 42.

The wear components 50 may be any suitable geometric shape for example triangular, circular, diamond, rectangular etc., are carried by the head plate 48 at the location corresponding to the location where high pressure and frictional forces occur. In the embodiment shown, wear components are triangular in shape and are located on corners of the front face 62 of the head plate 48.

The wear components 50 may be formed of any suitably material which is sufficiently non-compressible during the moulding process, for example plastic polymer, aluminium, steel etc. Preferably the wear components 50 are formed from a non-compressible plastic polymer.

The wear components 50 may be integrally formed with the head plate 48 or secured to the head plate 48 at desired locations as shown in FIG. 4.

Preferably the wear components 50 are secured to the head plate 48, and the filter sheet 52 and the wear components 50 are arranged such that they can be replaced while leaving the filter sheet 52 in position.

The wear components 50 may be secured to the head plate 48 by any suitable means such as welding, adhesive or fastening.

The filter sheet 52 is secured to the front face 62 of the head plate 48. The filter sheet 52 is preferably only secured along its periphery. The filter sheet 52 may be secured to the head plate 48 by means of an adhesive or by staples 54 as shown in FIG. 5.

The filter sheet 52 is preferably formed from a filter material. The filter material for forming the sheet 52 may be any material which is capable of permitting fluid to pass therethrough during the moulding process whilst restricting passage therethrough of particulate material above a predetermined size.

For example, the filter material may be a filter material as described in either UK patent 2365368 or UK patent 2358593.

Preferably the filter material is a woven or knitted fabric. For example, the filter material may be a filter fabric as described in UK patent 2277536.

The filter sheet 52 is sized and shaped to overlay the exposed front face 62 of the head plate 48, such that a side surface of the wear components 50 abuts a corresponding side face of the filter sheet 52. In use, a front surface of the wear components and a front surface of the filter assembly define the mould face 45 which makes contact with the cementitious material 66 within the press mould.

Referring now to FIGS. 6 and 7, the head plate 48 may comprise a plurality of perforations or apertures 68 spaced across its surface which are preferably arranged in an array of columns 70 and rows 72. The perforations 68 act to provide a flow path for water which is extracted from the cementitious material 66 during the pressing operation of a wet concrete press mould.

The wear components 50 may be secured to the head plate 48 by means of at least one fastener 80 extending from a first surface opposite the front surface, for securing the wear component 50 to the head plate 48. The head plate 48 having at least one corresponding socket 74 for receiving a respective fastner 80.

Preferably the wear components 50 are releasably secured to the head plate 48. As shown in FIG. 7, this may be achieved by means of fastener(s) 80 each in the form of a split pin.

Alternatively, as shown in FIG. 8, an alternative embodiment of a wear component 90 may be releasably secured to head plate 48 by means of a fastener in the form of a spigot 92 and screw 94 assembly.

In order to secure the wear component 90 to the head plate 48, the screw 94 is screwed into an end of the spigot 92, thereby holding the wear component 90 in position. The spigot 92 may comprise an internal thread for receiving the screw 94 or alternatively, the screw 94 may be a self-tapping screw, in which case the spigot 92 does not need to be threaded.

Preferably in such an arrangement, the spigot portion 92 of the fastener 80 depends from the wear component 90, as illustrated in FIG. 9.

Releasably securing the wear components 50,90 to the head plate 48 allows the wear components 50,90 to be easily replaced when required without the need to replace the whole head plate.

The front face 62 of the head plate 48 may comprise at least one recess 78 for carrying a wear component 50,90. The shape of the recess 78 corresponding to the shape of the wear component 50,90. The at least one recess 78 acts as a seat for positively locating the wear components 50,90.

The wear components 50,90 are carried by the head plate 48, such that the side surface of the weal components 50,90 also abuts against a shoulder defined by the recess 78, in order to restrict sideways movement of the wear components 50,90 relative to the head plate 48. Where the head plate 48 comprises a recess 78, the socket(s) 74 is located within the recess 78.

If the filter sheet 52 is secured to the head plate 48 by means of staples 54, the head plate 48 may further comprise a plurality of staple holes 76 arranged on the periphery of the head plate 48 to assist in the securing of the filter sheet 52 to the head plate 48. The staple holes 76 corresponding to the location of the staples 54 used for securing the filter sheet 52 to the head plate 48.

Turing now to FIG. 10, a cementitious press mould including the filter assembly according to a second embodiment of the invention fixed to a movable die head is shown.

The filter assembly is similar to the assembly previously described, with the exception that the wear components 82 further comprise a cover portion 84 which overlays a marginal edge of the filter sheet 52 adjacent the side face of the filter sheet 52.

The cover portion 84 of the wear components 82 may be integrally formed with the wear components 82. Alternatively a cover plate may be securely fixed onto the front surface of the wear components 50,90 to form a cover portion 84.

The addition of the cover portion 84 helps prevent cementitious particles from settling between the side surface of the wear components 50,90 and the side face filter sheet 52.

The settling of cementitious particles between the wear components 50,90 and the filter sheet 52 accelerates the wear of the filter sheet 52 and also diminishes the quality of the moulded product.

The cover portion 84 also allows the filter assembly 44 to be assembled without gaps between the wear components 50,90 and the filter sheet 52 being exposed to the mix.

Referring now to FIGS. 11 to 13, an integrally formed wear component 82 having a chamfered lateral side 86 is shown. The fastener for securing the wear component 82 to the head plate 48 (not shown in the figures) may either be in the form of a split pin or a spigot and screw assembly, as previously described.

1. A movable die head for a cementitious press mould, the die head having a mould face adapted to contact and apply compression to a mixture contained in the mould, the mould face being defined by at lest one wear component and a filter sheet, wherein each wear component is detachably mounted on the die head.

2. A die head according to claim 1 wherein the cementitious press mould comprises one of: a wet concrete press mould; a hermetic press mould; or semi-dry mix press mould.

3. A filter assembly, for use in a cementitious press mould, having a filter sheet and at least one wear component, the filter assembly defining a mould face adapted to contact and apply compression to a mixture contained in the mould, the at least one wear component and the filter sheet collectively defining said mould face, wherein each wear component is detachably mounted on a head plate of the press mould.

4. A filter assembly for a die head for a cementitious press mould, the die head having a mound face adapted to contact and apply compression to a mixture contained in the mould, the filter assembly defining the mould face for the die head, the filter assembly including a head plate which carries one or more wear components and to which a filter sheet is attached, the or each wear component and the filter sheet collectively defining said mould face, wherein each wear component is detachably mounted on the head plate.

5. A filter assembly according to claim 4 wherein the or each wear component is positioned at, or close to an edge of a front face of the head plate.

6. A filter assembly according to claim 5 wherein the front face of the head plate is polygonally shaped.

7. A filter assembly according to claim 6 wherein a said wear component is positioned at, or close to a corner of the front face of the head plate.

8. A filter assembly according to claim 4, wherein each wear component is detachably mounted on the head plate to enable removal and replacement of a worn wear component with the filter sheet remaining in situ.

9. A filter assembly according to claim 8 wherein the or each wear component is seated in a recess formed in the head plate, the recess defining a shoulder against which the wear component abuts to resist sideways movement of the wear component relative to the head plate.

10. A filter assembly according to claim 8, wherein the or each wear component is detachably secured to the plate by at least one fastener securely received in a corresponding socket formed in the head plate.

11. A filter assembly according to claim 10 wherein the at least one fastener comprises a pin depending from the wear component.

12. A filter assembly according to claim 11 wherein the pin comprises a split pin.

13. A filter assembly according to claim 10 wherein the at least one fastener comprises a spigot.

14. A filter assembly according to claim 13 wherein the spigot depends from the wear component.

15. A filter assembly according to claim 3, wherein the or each wear component comprises a lateral side which is chamfered.

16. A filter assembly according to claim 3, wherein the or each wear component has a marginal cover portion which overlies a marginal edge of the filter sheet.

17. A filter assembly according to claim 16 wherein the cover portion comprises a lateral side which is chamfered.

18. A filter assembly according to claim 3, wherein the or each wear component is formed of a non-compressible material.

19. A filter assembly according to claim 18 wherein the non-compressible material is a plastic polymer.

20. A filter assembly according to claim 3, wherein the filter sheet is formed from a filter material.

21. A filter assembly according to claim 20, wherein the filter sheet material is a knitted or woven fabric.

22. A filter assembly according to claim 3, wherein the cementitious press mould comprises one of: a wet concrete press mould; a hermetic press mould; or semi-dry mix press mould.

23. A wear component for a filter assembly as claimed in claim 3.

24-25. (canceled)

26. A filter assembly according to claim 4, wherein the or each wear component comprises a lateral side which is chamfered.

27. A filter assembly according to claim 4, wherein the or each wear component has a marginal cover portion which overlies a marginal edge of the filter sheet.

28. A filter assembly according to claim 27 wherein the cover portion comprises a lateral side which is chamfered.

29. A filter assembly according to claim 4, wherein the or each wear component is formed of a non-compressible material.

30. A filter assembly according to claim 29 wherein the non-compressible material is a plastic polymer.

31. A filter assembly according to claim 4, wherein the filter sheet is formed from a filter material.

32. A filter assembly according to claim 31, wherein the filter sheet material is a knitted or woven fabric.

33. A filter assembly according to claim 4 wherein the cementitious press mould comprises one of: a wet concrete press mould; a hermetic press mould; or semi-dry mix press mould.

34. A wear component for a filter assembly as claimed in claim 4.
